(19) United States
(12) Patent Application Publication
(10) Pub. No.: US 2017/0373907 A1
(43) Pub. Date: Dec. 28, 2017

(54) USE OF FREQUENCY OFFSET INFORMATION FOR WIRELESS NETWORKS

(71) Applicant: NOKIA SOLUTIONS AND NETWORKS OY, Espoo (FI)

(72) Inventors: Jun TAN, Lake Zurich, IL (US); Ren DA, Warren, NJ (US)

(21) Appl. No.: 15/632,100

(22) Filed: Jun. 23, 2017

Related U.S. Application Data
(60) Provisional application No. 62/355,324, filed on Jun. 27, 2016.

(51) Int. Cl. H04L 27/26; H04L 5/00; H04L 27/00

(52) U.S. Cl. CPC H04L 27/2657; H04L 5/003; H04L 27/2655; H04L 5/0007; H04L 27/2675; H04L 27/0014

(57) ABSTRACT

A technique includes receiving, by a user device from a base station in a wireless network, a frequency offset information (FOI), adjusting, by the user device, an uplink transmit frequency based on the frequency offset information, and transmitting, by the user device, at least one of data and control information to the base station based on the adjusted uplink transmit frequency.

### CROSS-REFERENCE TO RELATED APPLICATIONS

This application claims priority to U.S. Provisional Patent Application No. 62/355,324, filed Jun. 27, 2016, entitled “Use of Frequency Offset Information for Wireless Networks,” the disclosure of which is hereby incorporated by reference herein in its entirety.

### TECHNICAL FIELD

This description relates to communications, and in particular, to use of a frequency offset information, e.g., such as for Internet of Things (IoT) devices, which may include, for example, narrow-band Internet of Things (IoT) wireless networks/devices.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. 5G (or 5^{th} generation) wireless networks are also being developed.

### SUMMARY

According to an example implementation, a method may include receiving, by a user device from a base station in a wireless network, a frequency offset information (FOI); adjusting, by the user device, an uplink transmit frequency based on the frequency offset information; and transmitting, by the user device, at least one of data and control information to the base station based on the adjusted uplink transmit frequency.

According to an example implementation, an apparatus includes at least one processor and at least one memory including computer instructions, when executed by the at least one processor, cause the apparatus to: receive, by a user device from a base station in a wireless network, a frequency offset information (FOI); adjust, by the user device, an uplink transmit frequency based on the frequency offset information; and transmit, by the user device, at least one of data and control information to the base station based on the adjusted uplink transmit frequency.

According to an example implementation, an apparatus includes means for receiving, by a user device from a base station in a wireless network, a frequency offset information (FOI); means for adjusting, by the user device, an uplink transmit frequency based on the frequency offset information; and means for transmitting, by the user device, at least one of data and control information to the base station based on the adjusted uplink transmit frequency.

According to an example implementation, a computer program product includes a computer-readable storage medium and storing executable code that, when executed by at least one data processing apparatus, is configured to cause the at least one data processing apparatus to perform a method including: receiving, by a user device from a base station in a wireless network, a frequency offset information (FOI); adjusting, by the user device, an uplink transmit frequency based on the frequency offset information; and transmitting, by the user device, at least one of data and control information to the base station based on the adjusted uplink transmit frequency.

According to an example implementation, a method may include determining, by a base station for a user device in a wireless network, a frequency offset information (FOI); transmitting, by the base station to the user device, the frequency offset information; and receiving, by the base station, an uplink transmission from the user device in which an uplink transmit frequency has been adjusted based on the frequency offset information.

According to an example implementation, an apparatus includes at least one processor and at least one memory including computer instructions, when executed by the at least one processor, cause the apparatus to: determine, by a base station for a user device in a wireless network, a frequency offset information (FOI); transmit, by the base station to the user device, the frequency offset information; and receive, by the base station, an uplink transmission from the user device in which an uplink transmit frequency has been adjusted based on the frequency offset information.

According to an example implementation, an apparatus includes means for of portions of the packet are performed by the transmitter.

According to an example implementation, a computer program product includes a computer-readable storage medium and storing executable code that, when executed by at least one data processing apparatus, is configured to cause the at least one data processing apparatus to perform a method including: determining, by a base station for a user device in a wireless network, a frequency offset information (FOI); transmitting, by the base station to the user device, the frequency offset information; and receiving, by the base station, an uplink transmission from the user device in which an uplink transmit frequency has been adjusted based on the frequency offset information.

According to an example implementation, an apparatus may include means for determining, by a base station for a user device in a wireless network, a frequency offset information (FOI); means for transmitting, by the base station to the user device, the frequency offset information; and means for receiving, by the base station, an uplink transmission from the user device in which an uplink transmit frequency has been adjusted based on the frequency offset information.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a flow chart illustrating operation of a user device/user equipment (UE) according to an example implementation.

FIG. 3 is as flow chart illustrating operation of a base station (BS)/eNB according to an example implementation.

FIG. 4 is a diagram illustrating a communication of frequency offset information (FOI) according to an example implementation.

FIG. 5 is a block diagram of a node or wireless station (e.g., base station/access point or mobile station/user device/UE) according to an example implementation.

### DETAILED DESCRIPTION

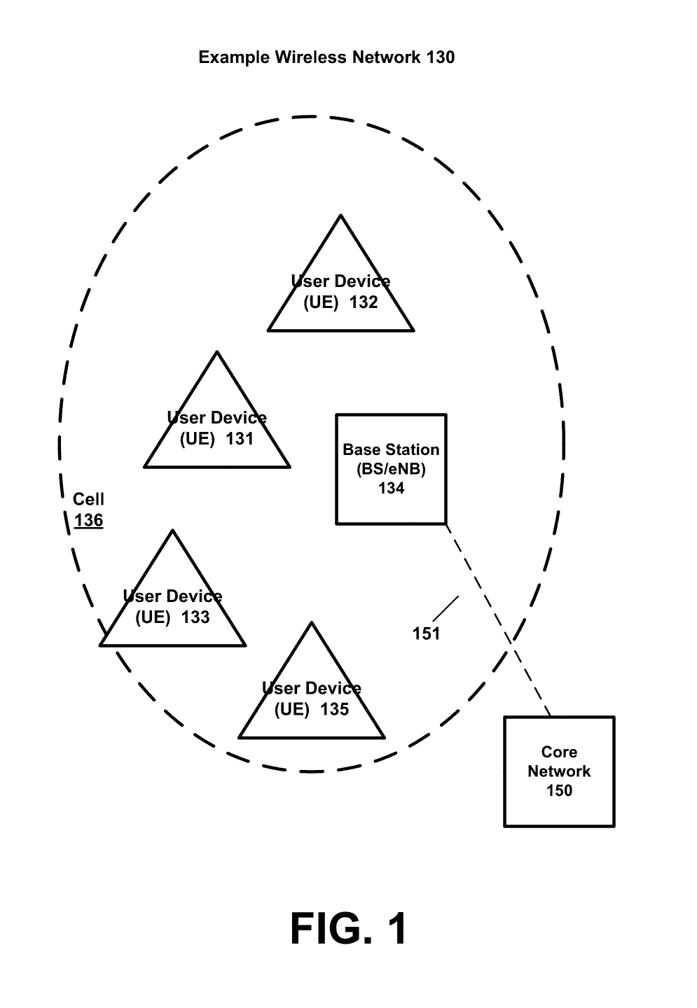

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a 51 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network. A user device (or UE) may also include an Internet of Things (IoT) user device/UE, such as for example, a narrowband Internet of Things (NB-IoT) user device/UE.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, or any other wireless network. LTE, 5G, cmWave and mmWave band networks are provided only as illustrative examples, and the various example implementations may be applied to any wireless technology/wireless network.

For example, in an illustrative implementation, the various techniques or implementations described herein may be applied to Internet of Things (IoT) devices/user devices, such as narrowband (NB) IoT (NB-IoT) devices. IoT may refer to an ever-growing group of objects or devices that may have Internet or network connectivity, so that these objects may send information to and receive information from other network devices. For example, many sensor type applications or devices may monitor a physical condition or a status, and may send a report to a server or other network device, e.g., periodically or when an event occurs, by way of illustrative example.

According to an example implementation, narrow band IoT (NB-IoT) may include a Rel (release)-13 3GPP technique of radio access based on cellular Internet of things (IoT). Other IoT devices and technologies may also be used, as this is merely an illustrative example of IoT technology. According to an example implementation, the NB-IoT technique may provide improved indoor coverage, support for massive number of low throughput devices, low delay sensitivity, ultra-low device cost, low device power consumption, and optimized network architecture. According to an example implementation, there may include operations for NB-IoT: standalone (e.g., where the IoT devices use resources separate from LTE to transmit and receive data/signals), in-band (e.g., where the IoT devices use resources, such as one PRB/physical resource block, within the resources allocated to LTE device), and guard band (e.g., where IoT devices are allocated resources within a guard band of LTE bandwidth) operation. At least in some cases, a single synchronization signal design may be applied for all 3 operation modes. For uplink, single tone with either a bandwidth of 15 kHz or 3.75 kHz is supported with improved coverage at low data transmission rate. The RACH (random access channel) waveform/signal/preamble of an example NB-IoT, for example, is (or may be) based on a 3.75 kHz bandwidth single-tone with frequency hopping. The Narrowband Physical Uplink Shared Channel (NPUSCH) may be transmitted on 3.75 kHz or 15 KHz (bandwidth signal) single-tone, or 15 KHz multi-tones with the maximum 12 tones, or maximum bandwidth of 180 KHz, which is the bandwidth of 1 Physical Resource Block (PRB) in LTE.

As with legacy UEs (which may include 3G and/or 4G/LTE UEs, for example), IoT UEs, such as NB-IoT UEs, may also be required to be time synchronized and frequency synchronized with the serving cell. According to an example implementation, initial frequency synchronization with a cell may be achieved during a cell search procedure where a UE performs time and frequency synchronization with the serving cell by measuring the narrowband synchronization signals, namely the narrowband primary synchronization signal (NPSS) and narrowband secondary synchronization signal (NSSS), which are transmitted in the downlink synchronization channel from the serving cell.

According to an example implementation, further timing synchronization may be achieved through the feedback from the BS/eNB by the use of the timing advance command (providing a timing advance information (TAI)), e.g., determined by the BS/eNB based on the received RACH preamble. As an illustrative example, at the connection setup, after receiving the narrowband physical random access channel (NPRACH) preamble from the UE, the eNB may estimate the timing offset of the UE based on the received NPRACH preamble, and send back the Timing Advance (TA) Command (e.g., including timing advance information/TAI) within the Random Access Response (RAR). Upon reception of a timing advance command, the UE will adjust uplink transmission timing for Narrowband Physical Uplink Shared Channel (NPUSCH) based on the received Timing Advance information (TAI). Also, for example, for a UE in the connected state, the BS/eNB may also continuously estimate the timing offset of the UE based on the received NPUSCH signals, and may send TA information (TAI) to the UE for UE to adjust uplink transmission timing for NPUSCH whenever it is necessary. According to an example implementation, this process may be performed in a random access (RACH) procedure.

RACH (random access) channel is an initial uplink access channel for a UE/user device. A UE may initiate/transmit a RACH preamble, e.g., at the broadcasted RACH window; and the B S/eNB will respond to the RACH request/preamble with a random access response (RAR) once the eNB/BS detects the RACH request. According to an example implementation, the RAR may include one or more of the following information, and may include additional information:
1) Random Access Radio Network Temporary Identifier (RA-RNTI); identifying time-frequency resource in which RACH preamble is detected.
2) Assignment of Cell Radio Network Temporary Identifier (C-RNTI)—an identifier for the UE within the cell.
3) Initial uplink resource grant for transmitting following message—this grants UL resource to allow the UE to transmit to the BS/eNB.
4) Timing advance (TA) information (TAI) to allow the UE/user device, to adjust synchronization of the subsequent uplink transmissions to the BS/eNB.
5) Possible backoff indicator.
6) As described in greater detail below, according to an example implementation, the RAR may also include a frequency offset information (FOI), sent from the eNB/BS to the UE/user device, to allow the UE to adjust or correct its uplink transmission frequency. The FOI may also be sent to the UE via other messages, such as via downlink control information (DCI), etc.

Upon reception of the timing advance information (TAI), the UE/user device may adjust uplink transmission timing for Narrowband Physical Uplink Shared Channel (NPUSCH). Once the UE is in the connected state, the eNB/BS may periodically or continuously estimate UE timing offset (TAI) based on the received NPUSCH signals, and send back the Timing Advance (TA) Command (including the TAI) to the UE for UE to adjust its uplink transmission timing whenever it is necessary.

According to an example implementation, a frequency error may occur for the uplink transmission frequency or UL carrier frequency. According to an example implementation, a frequency error may be (or may include) a difference between the uplink carrier frequency received by the BS/eNB from the UE and a nominal carrier frequency of these uplink signals, for example. For example, for a TDD (time division duplex) wireless system in which one band or carrier frequency may be used for both uplink and downlink transmission, a frequency error may be a difference between the UE modulated uplink carrier frequency transmitted by the UE/user device and the downlink modulated carrier frequency transmitted by the BS/eNB. For a FDD (frequency division duplex) wireless system, the uplink carrier frequency and the downlink carrier frequency are provided on fixed and different carrier frequencies, e.g., where there may typically be a fixed separation between the downlink carrier frequency and the uplink carrier frequency. Thus, for example, for a FDD system, a frequency error may be (or may include) a difference between the uplink carrier frequency transmitted by the UE/user device and the nominal or expected UL carrier frequency.

In some cases, a maximum frequency error may be specified or allowed for an UL transmission. As an illustrative example, a maximum frequency error may be 0.2 ppm (0.2 parts per million) for carrier frequency <1 GHz, which is a maximum frequency error of 200 Hz at a carrier frequency of 1 GHz, for example. Excessive frequency error in an uplink transmission may decrease demodulation/decoding performance at the BS/eNB. There may be a number of causes of a frequency error (or a number of factors that may contribute to a frequency error) such as, for example: fading channels, Doppler shift due to a moving UE/user device, and in particular, frequency errors introduced due to variations and/or imperfections in transmission hardware performance, etc., which may cause the transmission frequency to drift over time. For example, for a low cost NB-IoT, frequency offset may be quite significant, at least in some cases.

For example, frequency drift may occur over time, and may, at least in some cases, be problematic for IoT devices. For example, unlike legacy UEs/user devices, according to an example implementation, some (or many of the expected) NB-IoT UEs can only work in half-duplex mode, which means that the NB-IoT UE cannot perform transmitting uplink signals and receiving downlink reference signals at the same time. Therefore, in such an example situation, the IoT UE will not be able to continuously adjust its UL transmission frequency based on a downlink received frequency, since, for example, in such a case, a half-duplex IoT UE may be able to either transmit a signal in the uplink direction, or a receive a signal in the downlink direction at a time, but not both. Therefore, for such a half-duplex UE, uplink frequency drift may occur while transmitting an uplink signal over a period of time. Furthermore, as another example of a situation that may introduce frequency drift and/or frequency error, in some cases low (or lower) cost crystal oscillators, such as digital controlled crystal oscillators (DCXOs), are or may be used in IoT UEs or NB-IoT UEs to reduce the device cost. DCXOs are in general less stable than temperature compensated crystal oscillator (TCXOs), which are currently commonly used for mobile handsets. Therefore, NB-IoT UE transmit frequency drifting or transmit frequency errors may be expected to be larger than legacy (e.g., LTE) UEs, at least in some cases. Other factors or situations may cause a frequency drift or frequency error(s) to occur for IoT UEs, such as for NB-IoT UEs, for example.

Therefore, according to an example implementation, a BS/eNB may determine a frequency offset information (FOI) based on an uplink signal received from the user device. The BS/eNB may then provide the FOI to the user device/UE. The user device/UE may then adjust its uplink transmission frequency based on the FOI, e.g., to at least reduce any uplink frequency error.

According to an example implementation, the eNB/BS may determine the FOI based on a received random access channel (RACH) preamble received from a UE, or based on a RACH (random access channel) preamble sent via NPRACH (narrowband physical random access channel), e.g., for a UE in an idle or unconnected state. Or, a eNB/BS may determine the FOI for a UE based on another signal received from the UE, such as based on uplink demodulation reference signals received by the eNB/BS from the UE/user device via a physical uplink shared channel (PUSCH), or based on other signals received from the UE via NPUSCH (narrowband physical uplink shared channel). According to an example implementation, the BS/eNB may determine both the TAI and FOI by, e.g., cross-correlating and/or auto-correlating the received signal (e.g., either the RACH preamble or uplink demodulation reference signals, or other signal) with an expected signal or a signal generated by the eNB. In the case of the eNB determining the FOI based on a received RACH preamble, the TAI and FOI may be sent or transmitted by the eNB/BS to the UE via a random access response (RAR), for example. In an example where the eNB determines the FOI for a connected UE, e.g., based on the received demodulation reference signals or other signals, the eNB may send or transmit the FOI to the UE via downlink control information (DCI) that is provided on a physical downlink control channel, or via other message or channel. These are merely some examples, and the FOI may be determined/calculated and sent to the UE using other techniques.

According to an example implementation, at the eNB, when either a RACH preamble via NPRACH (narrowband physical random access channel) and/or synchronization signals via NPUSCH are detected and demodulated from a particular NB-IoT UE, the eNB may then estimate both the frequency offset information (FOI) and timing advance information (TAI) for that NB-IoT UE. For example, a eNB/BS may auto-correlate the received uplink signal or cross-correlate an uplink signal received from a UE with an expected signal or a signal generated by the eNB/B S, to determine the TAI and FOI for the UE. For example, the current RACH (random access) procedure only provides TA (timing advance) information (TAI) to the UE so that UE may adjust its uplink transmission timing. The current RACH (random access) procedure does not support the eNB to provide a frequency offset information (FOI) to the UE. For legacy LTE systems, this (absence of signaling the FOI from eNB to UE), at least in some cases, may be sufficient for one or more reasons, such as, for example:

a) since LTE is a wide-band system with minimum bandwidth of 6PRBs (1.08 MHz);

b) UE may continue monitoring LTE DL (downlink) reference signals for frequency synchronization (e.g., this may be facilitated by full-duplex operation or LTE UEs); and

c) relatively higher quality oscillators may, at least in some cases, be used in legacy (e.g., LTE) UEs than are (or expected to be) in NB-IoT UEs, so there may be less transmit frequency drift for legacy UEs, as compared to NB-IoT UEs, for example.

However, according to an example implementation, for a narrow band system with only 3.75 kHz signal bandwidth such as NB-IoT, uplink transmit frequency error, in the absence of FOI, may significantly impact demodulation/decoding performance at the eNB/BS, e.g., due to uplink transmit frequency drift, which may become worse during uplink transmission repetitions, when NB-IoT UEs are unable to measure DL synchronization or reference signals for frequency offset estimation and/or where fast frequency drift may occur due to the use of low quality oscillators.

IoT UEs have been described as an illustrative example of the type of devices where various implementations of FOI signaling may be used. However, FOI signaling technique(s), according to one or more various example implementations, may be implemented in any UE/user device (any wireless devices), such as IoT UEs and/or NB-IoT UEs that are merely described as illustrative examples, and the various example implementations are not limited thereto.

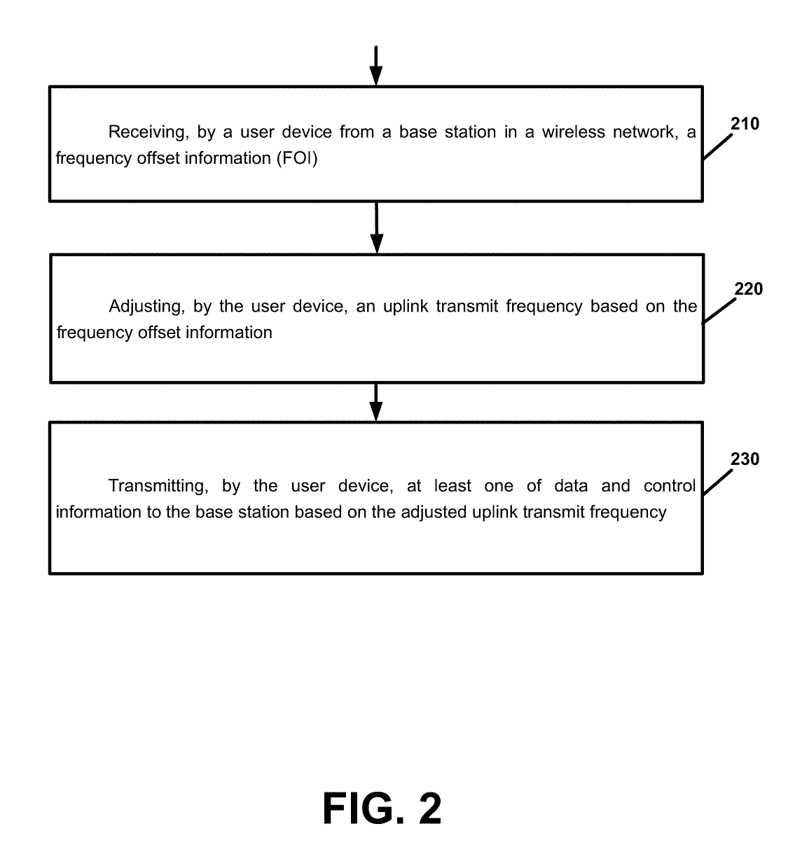

FIG. 2 is a flow chart illustrating operation of a user device/user equipment (UE) according to an example implementation. Operation 210 includes receiving, by a user device from a base station in a wireless network, a frequency offset information (FOI). Operation 220 includes adjusting, by the user device, an uplink transmit frequency based on the frequency offset information. Operation 230 includes transmitting, by the user device, at least one of data and control information to the base station based on the adjusted uplink transmit frequency.

According to an example implementation of the method of FIG. 2, the frequency offset information indicates at least one of the following: a frequency difference, as measured by the base station, as a difference in a frequency of a signal transmitted by the user device and an expected frequency; and a frequency adjustment that should be performed for an uplink transmit frequency for the user device to correct an uplink transmit frequency of the user device.

According to an example implementation of the method of FIG. 2, the frequency difference may include a difference in a frequency of a random access preamble transmitted by the user device, and an expected frequency for the random access preamble.

According to an example implementation of the method of FIG. 2, the receiving a frequency offset information may include: receiving, by the user device from the base station, a random access response including at least the frequency offset information.

According to an example implementation of the method of FIG. 2, the receiving a frequency offset information may include: transmitting, by the user device to the base station, a random access preamble; and, receiving, by the user device from the base station, a random access response including at least a timing advance information and the frequency offset information.

According to an example implementation of the method of FIG. 2, the frequency difference may include a difference in a frequency of an uplink demodulation reference signals received via a narrowband physical uplink shared (NPUSCH) channel and a nominal or expected frequency of the uplink demodulation reference signals.

According to an example implementation of the method of FIG. 2, the receiving a frequency offset information may include: receiving, by the user device from the base station via a physical downlink control channel, a downlink control information (DCI) that includes at least the frequency offset information.

According to an example implementation of the method of FIG. 2, the receiving may include receiving, by a narrow band-Internet of Things (NB-IoT) user device from a base station in a wireless network, a frequency offset information; wherein the adjusting comprises adjusting, by the NB-IoT user device, an uplink transmit frequency based on the frequency offset information; and wherein the transmitting comprises transmitting, by the NB-IoT user device, at least one of data and control information to the base station based on the adjusted uplink transmit frequency.

According to an example implementation of the method of FIG. 2, the user device may include an Internet of Things (IoT) user device.

According to an example implementation of the method of FIG. 2, the user device may include a narrowband-Internet of Things (NB-IoT) user device.

According to an example implementation, an apparatus includes at least one processor and at least one memory including computer instructions, when executed by the at least one processor, cause the apparatus to: receive, by a narrow band-Internet of Things (NB-IoT) user device from a base station in a wireless network, a frequency offset information (FOI); adjust, by the NB-IoT user device, an uplink transmit frequency based on the frequency offset information; and transmit, by the NB-IoT user device, at least one of data and control information to the base station based on the adjusted uplink transmit frequency.

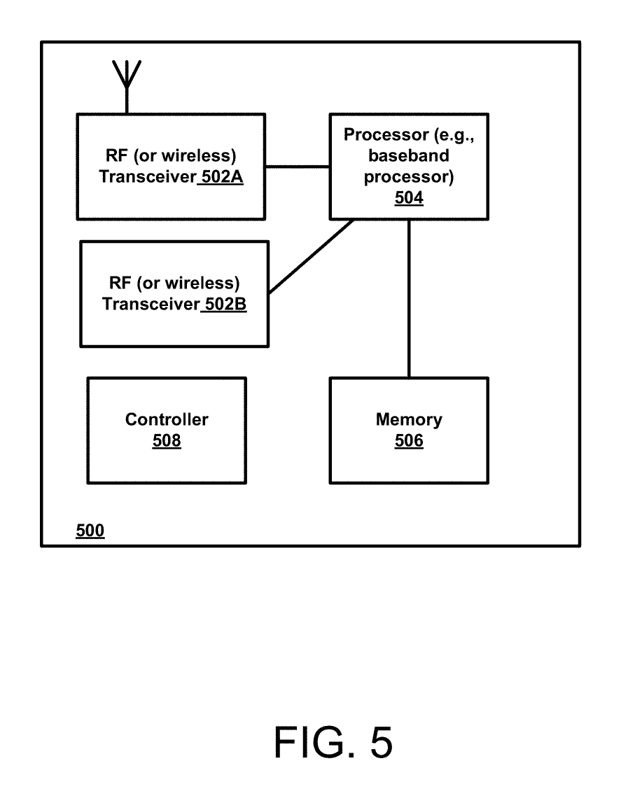

An apparatus includes means (e.g., 502A/502B, and/or 504, FIG. 5) for receiving, by a user device from a base station in a wireless network, a frequency offset information (FOI); means (e.g., 502A/502B, and/or 504, FIG. 5) for adjusting, by the user device, an uplink transmit frequency based on the frequency offset information; and means (e.g., 502A/502B, and/or 504, FIG. 5) for transmitting, by the user device, at least one of data and control information to the base station based on the adjusted uplink transmit frequency.

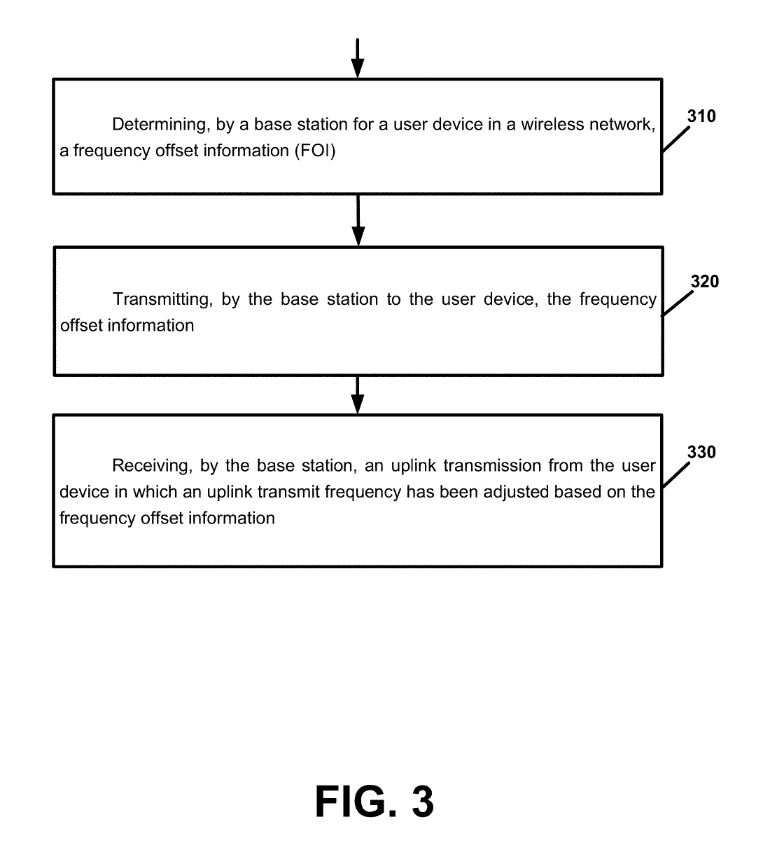

FIG. 3 is as flow chart illustrating operation of a base station (BS)/eNB according to an example implementation. Operation 310 includes determining, by a base station for a user device in a wireless network, a frequency offset information (FOI). Operation 320 includes transmitting, by the base station to the user device, the frequency offset information. Operation 330 includes receiving, by the base station, an uplink transmission from the user device in which an uplink transmit frequency has been adjusted based on the frequency offset information.

According to an example implementation of the method of FIG. 3, the determining may include: receiving, by the base station, a random access channel preamble from the user device; and determining the frequency offset information based on the received random access channel preamble.

According to an example implementation of the method of FIG. 3, the determining a frequency offset information based on the received random access channel preamble may include: determining the frequency offset information by correlating or cross-correlating the received random access channel preamble against an expected preamble to determine the frequency offset information for the user device.

According to an example implementation of the method of FIG. 3, the frequency offset information indicates at least one of the following: a frequency difference, as measured by the base station, as a difference in a frequency of a signal transmitted by the user device, and an expected frequency; and a frequency adjustment that should be performed for a transmit frequency for the user device to correct the transmit frequency of the user device.

According to an example implementation of the method of FIG. 3, the frequency offset information is based on a difference in a frequency of a random access preamble received by the base station from the user device, and an expected frequency for the random access preamble.

According to an example implementation of the method of FIG. 3, the transmitting a frequency offset information may include at least one of the following: transmitting, by the base station to the user device, a random access response including at least the frequency offset information; and transmitting, by the base station to the user device a downlink control information (DCI) that includes at least the frequency offset information.

According to an example implementation of the method of FIG. 3, the frequency difference may include a difference in a frequency of an uplink demodulation reference signals received via a narrowband physical uplink shared (NPUSCH) channel and a nominal or expected frequency of the uplink demodulation reference signals.

According to an example implementation, a computer program product includes a computer-readable storage medium and storing executable code that, when executed by at least one data processing apparatus, is configured to cause the at least one data processing apparatus to perform a method of: determining, by a base station for a user device in a wireless network, a frequency offset information (FOI); transmitting, by the base station to the user device, the frequency offset information; and receiving, by the base station, an uplink transmission from the user device in which an uplink transmit frequency has been adjusted based on the frequency offset information.

An apparatus includes at least one processor and at least one memory including computer instructions, when executed by the at least one processor, cause the apparatus to: determine, by a base station for a user device in a wireless network, a frequency offset information (FOI); transmit, by the base station to the user device, the frequency offset information; and receive, by the base station, an uplink transmission from the user device in which an uplink transmit frequency has been adjusted based on the frequency offset information.

An apparatus includes means (e.g., 502A/502B, and/or 504, FIG. 5) for determining, by a base station for a user device in a wireless network, a frequency offset information (FOI); means (e.g., 502A/502B, and/or 504, FIG. 5) for transmitting, by the base station to the user device, the frequency offset information; and means (e.g., 502A/502B, and/or 504, FIG. 5) for receiving, by the base station, an uplink transmission from the user device in which an uplink transmit frequency has been adjusted based on the frequency offset information.

Thus, according to an example implementation, signaling (via various messages) is provided so that the eNB may send UE-specific frequency offset information (FOI) to the UE. For example, the BS may determine the FOI for a UE based on uplink demodulation reference signals or based on synchronization signal received by the eNB via the NPUSCH (e.g., physical uplink shared channel/narrowband physical uplink shared channel), or based on a random access preamble sent by the UE to the eNB via the NPRACH (random access channel/narrowband physical random access channel). The BS/eNB may determine the UE-specific FOI, e.g., based on a cross-correlation of the received signal with an expected signal or signal generated by the eNB. The FOI may be sent by the eNB to the UE, e.g., via a random access response (RAR), via a downlink control information (DCI), or other message or signal. Then, the UE may adjust or correct its uplink transmit frequency by (or based on) the FOI received from the eNB.

According to an example implementation, the signaling or communication of frequency-offset information (FOI) can be transmitted either together with TAI or alone under the same conditions whenever the TAI can be transmitted, or in other conditions or via other messages, which may include one or more of the following scenarios:

The FOI can be included in the RAR (random access response).

The FOI can be included in downlink control channel or a narrowband physical downlink control channel (NPDCCH) downlink control information (DCI).

Also, according to an example implementation, the NB-IoT RACH (random access) procedure can be updated with (one or more of) these steps: An IoT UE (e.g., a NB-IoT UE) sends its RACH (random access) preamble with a single-tone RACH waveform to the eNB/BS; the eNB detects the RACH preamble with estimation of timing of arrival (ToA) and frequency offset for the received RACH preamble; the eNB may determine a TAI based on the ToA. Or, for example, the eNB may auto-correlate the received uplink signal or cross-correlate the received random access preamble with an expected random access preamble or eNB-generated preamble. According to an example implementation, auto-correlation may include performing a correlation (or correlating) between the received signal and the signal with a fixed timing-delay. The RAR, e.g., including the TAI and FOI is transmitted in DL data channel. One embodiment includes that the UE-specific FOI is sent at a persistent window (persistent time resource) with a specific configuration. In another embodiment, the FOI can be incorporated with NPDCCH DCI information.

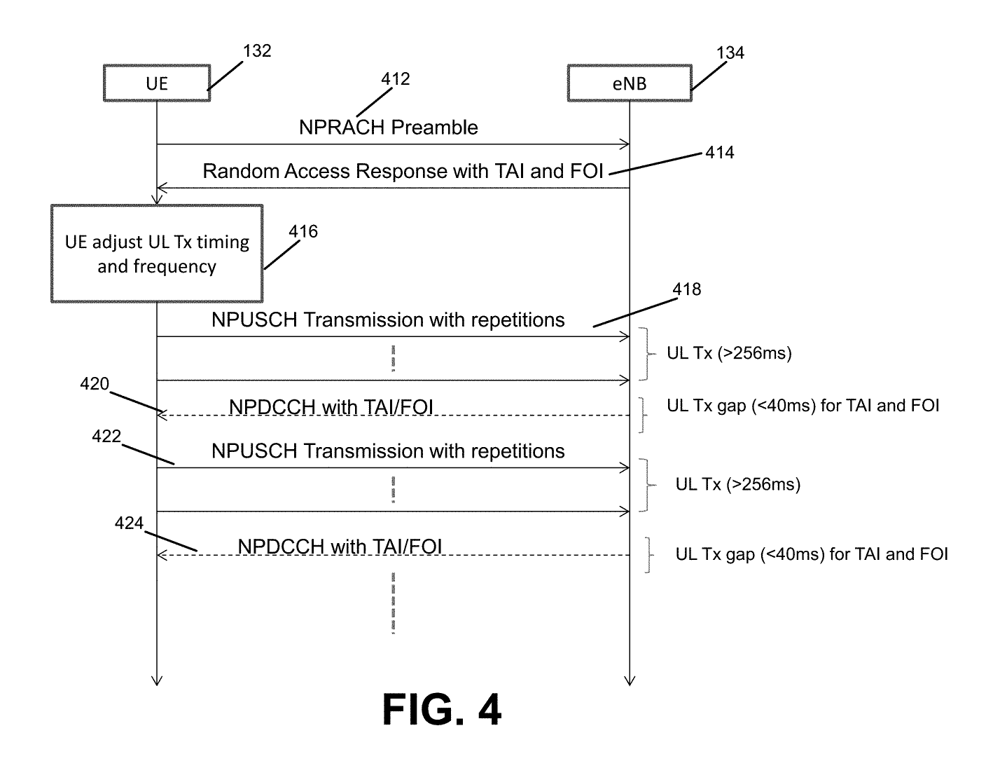

FIG. 4 is a diagram illustrating a communication of frequency offset information (FOI) according to an example implementation. A UE 132 is in communication with a eNB/BS 134. Initially, the UE 132 may not be connected to the eNB. At 412, the UE 132 may send a random access preamble (e.g., NPRACH preamble). At 414, the eNB may determine the TAI and FOI, e.g., based on an auto-correlation or a cross-correlation of the received RACH preamble, and then sends a random access response (RAR), which includes the TAI and FOI, to the UE 132. At 416, the UE 132 may adjust or correct its uplink transmit frequency based on the received FOI. For example, the FOI may indicate a frequency amount to adjust (e.g., increase or decrease) a current or previous uplink transmit frequency.

As shown in FIG. 4, at 418, the UE 132 sends data and/or control information to the eNB based on or using the adjusted uplink transmit frequency. For example, at 418, the UE 132 may send a NPUSCH (e.g., data and control information) transmission with repetitions (e.g., where data is sent multiple times). The transmission received at 418 may include uplink demodulation reference signals, or other signals, that may be used by eNB to determine an updated TAI and FOI for the UE 132. The eNB 134 may then determine an updated FOI for the UE based on the received NPUSCH transmission. At 420, the eNB 134 then sends the updated TAI and FOI via downlink control channel, such as via DCI of NPDCCH, for example. The process repeats at 422 and 424, with uplink data and/or control information received at 422. At 424, the eNB 134 may determine updated TAI and FOI for the UE based on data and/or control information received at 422, and the updated TAI/FOI are then sent to the UE 132 (at 424).

Therefore, after the UE is connected to the eNB 134, e.g., based on the RAR received at 414, the eNB may determine updated FOI (which may have changed due to transmit frequency drift, etc.) for the UE 132 based on uplink demodulation reference signals (or other signals) transmitted by the (connected) UE 132 to eNB 134, e.g., at 418 and 422. The eNB 134 may auto-correlate the received signal or cross-correlate the received reference signals from the UE with an expected set of reference signals, e.g., to determine/detect the updated FOI for the UE 132. The eNB 134 may then send the FOI for the UE to the UE 132, e.g., via downlink control information (DCI) that may be sent in a physical downlink control channel, or via other signal or message, e.g., at 420 and 424.

According to an example implementation, the uplink data and control information may be transmitted (418, 422) by the UE 132 to the eNB 134 during transmission periods, e.g., which may be greater than 256 ms, while a transmission of the FOI information may be transmitted (at 420, 424) during uplink transmission gaps, e.g., which may be less than 40 ms, according to an illustrative example.

FIG. 5 is a block diagram of a wireless station (e.g., AP or user device) 500 according to an example implementation. The wireless station 500 may include, for example, one or two RF (radio frequency) or wireless transceivers 502A, 502B, where each wireless transceiver includes a transmitter to transmit signals and a receiver to receive signals. The wireless station also includes a processor or control unit/entity (controller) 504 to execute instructions or software and control transmission and receptions of signals, and a memory 506 to store data and/or instructions.

Processor 504 may also make decisions or determinations, generate frames, packets or messages for transmission, decode received frames or messages for further processing, and other tasks or functions described herein. Processor 504, which may be a baseband processor, for example, may generate messages, packets, frames or other signals for transmission via wireless transceiver 502A or 502B. Processor 504 may control transmission of signals or messages over a wireless network, and may control the reception of signals or messages, etc., via a wireless network (e.g., after being down-converted by wireless transceiver 502, for example). Processor 504 may be programmable and capable of executing software or other instructions stored in memory or on other computer media to perform the various tasks and functions described above, such as one or more of the tasks or methods described above. Processor 504 may be (or may include), for example, hardware, programmable logic, a programmable processor that executes software or firmware, and/or any combination of these. Using other terminology, processor 504 and transceiver 502 together may be considered as a wireless transmitter/receiver system, for example.

In addition, referring to FIG. 5, a controller (or processor) 508 may execute software and instructions, and may provide overall control for the station 500, and may provide control for other systems not shown in FIG. 5, such as controlling input/output devices (e.g., display, keypad), and/or may execute software for one or more applications that may be provided on wireless station 500, such as, for example, an email program, audio/video applications, a word processor, a Voice over IP application, or other application or software.

In addition, a storage medium may be provided that includes stored instructions, which when executed by a controller or processor may result in the processor 504, or other controller or processor, performing one or more of the functions or tasks described above.

According to another example implementation, RF or wireless transceiver(s) 502A/502B may receive signals or data and/or transmit or send signals or data. Processor 504 (and possibly transceivers 502A/502B) may control the RF or wireless transceiver 502A or 502B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving, by a user device from a base station in a wireless network, a frequency offset information (FOI);
adjusting, by the user device, an uplink transmit frequency based on the frequency offset information; and
transmitting, by the user device, at least one of data and control information to the base station based on the adjusted uplink transmit frequency.

2. The method of claim 1 wherein the frequency offset information indicates at least one of the following:
a frequency difference, as measured by the base station, as a difference in a frequency of a signal transmitted by the user device and an expected frequency; and
a frequency adjustment that should be performed for an uplink transmit frequency for the user device to correct an uplink transmit frequency of the user device.

3. The method of claim 2 wherein the frequency difference comprises a difference in a frequency of a random access preamble transmitted by the user device, and an expected frequency for the random access preamble.

4. The method of claim 1, wherein the receiving a frequency offset information comprises:
receiving, by the user device from the base station, a random access response including at least the frequency offset information.

5. The method of claim 1, wherein the receiving a frequency offset information comprises:
transmitting, by the user device to the base station, a random access preamble;
receiving, by the user device from the base station, a random access response including at least a timing advance information and the frequency offset information.

6. The method of claim 2 wherein the frequency difference comprises a difference in a frequency of an uplink demodulation reference signals received via a narrowband physical uplink shared (NPUSCH) channel and a nominal or expected frequency of the uplink demodulation reference signals.

7. The method of claim 1, wherein the receiving a frequency offset information comprises:
receiving, by the user device from the base station via a physical downlink control channel, a downlink control information (DCI) that includes at least the frequency offset information.

8. The method of claim 7:
wherein the receiving comprises receiving, by a narrow band-Internet of Things (NB-IoT) user device from a base station in a wireless network, a frequency offset information;
wherein the adjusting comprises adjusting, by the NB-IoT user device, an uplink transmit frequency based on the frequency offset information; and
wherein the transmitting comprises transmitting, by the NB-IoT user device, at least one of data and control information to the base station based on the adjusted uplink transmit frequency.

9. The method of claim 1 wherein the user device comprises an Internet of Things (IoT) user device.

10. The method of claim 1 wherein the user device comprises a narrowband-Internet of Things (NB-IoT) user device.

11. A computer program product, the computer program product comprising a computer-readable storage medium and storing executable code that, when executed by at least one data processing apparatus, is configured to cause the at least one data processing apparatus to perform a method claim 1.

12. An apparatus comprising at least one processor and at least one memory including computer instructions, when executed by the at least one processor, cause the apparatus to:
receive, by a user device from a base station in a wireless network, a frequency offset information (FOI);
adjust, by the user device, an uplink transmit frequency based on the frequency offset information; and
transmit, by the user device, at least one of data and control information to the base station based on the adjusted uplink transmit frequency.

13. A method, comprising:
determining, by a base station for a user device in a wireless network, a frequency offset information (FOI);
transmitting, by the base station to the user device, the frequency offset information; and
receiving, by the base station, an uplink transmission from the user device in which an uplink transmit frequency has been adjusted based on the frequency offset information.

14. The method of claim 13 wherein the determining comprises:
receiving, by the base station, a random access channel preamble from the user device; and
determining the frequency offset information based on the received random access channel preamble.

15. The method of claim 14 wherein the determining a frequency offset information based on the received random access channel preamble comprises:
determining the frequency offset information by correlating or cross-correlating the received random access channel preamble against an expected preamble to determine the frequency offset information for the user device.

16. The method of claim 13 wherein the frequency offset information indicates at least one of the following:
a frequency difference, as measured by the base station, as a difference in a frequency of a signal transmitted by the user device, and an expected frequency; and
a frequency adjustment that should be performed for a transmit frequency for the user device to correct the transmit frequency of the user device.

17. The method of claim 13 wherein the frequency offset information is based on a difference in a frequency of a random access preamble received by the base station from the user device, and an expected frequency for the random access preamble.

18. The method of claim 13, wherein the transmitting a frequency offset information comprises at least one of the following:
transmitting, by the base station to the user device, a random access response including at least the frequency offset information; and
transmitting, by the base station to the user device a downlink control information (DCI) that includes at least the frequency offset information.

19. The method of claim 16 wherein the frequency difference comprises a difference in a frequency of an uplink demodulation reference signals received via a narrowband physical uplink shared (NPUSCH) channel and a nominal or expected frequency of the uplink demodulation reference signals.

20. An apparatus comprising at least one processor and at least one memory including computer instructions, when executed by the at least one processor, cause the apparatus to perform the method of claim 13.
